(19) United States
(12) Patent Application Publication
(10) Pub. No.: US 2018/0036207 A1
(43) Pub. Date: Feb. 8, 2018

(54) BABY BOTTLE NIPPLE AND CONFIGURATIONS THEREOF

(71) Applicant: Edgardo Clores, Las Vegas, NV (US)

(72) Inventor: Edgardo Clores, Las Vegas, NV (US)

(21) Appl. No.: 15/226,713

(22) Filed: Aug. 2, 2016

(51) Int. Cl. A61J 11/00; A61J 9/00; A61J 11/04

(52) U.S. Cl. CPC A61J 11/002; A61J 11/04; A61J 9/00

(57) ABSTRACT

The present disclosure relates to a baby bottle nipple and provides multiple configurations to that system. More particularly, this disclosure describes a nipple for reducing or preventing the amount of liquid released due to accidental spillage when a baby is not feeding. In one illustrative embodiment, the nipple may include an opening and an interior chamber. A sealing wall within the interior chamber may form an air space before the opening of the nipple. The air space may prevent passage of a liquid through the sealing wall when subject to normal atmospheric conditions and may permit passage of the liquid through the opening when subject to an applied pressure differential.

### TECHNICAL FIELD

This disclosure generally relates to a baby bottle nipple, and more particularly, to a nipple with a sealing wall to form an air space that prevents passage of liquid through an opening.

### BACKGROUND

A baby bottle nipple may allow a baby or infant to drink liquids. These liquids may include formula, breast milk, water, or other fluid. A number of nipples currently exist in the market. Orthodontic nipples, for example, may provide a flattened look while angled nipples may be slanted to tilt into a baby's mouth. Vented nipples may include a tiny hole to allow air to flow while liquid is taken out.

Unfortunately, these nipples have drawbacks. Liquids may accidentally be released when, for example, a bottle having the nipple is tipped or dropped. The nipples may also release liquid when a baby is not sucking which may lead to choking. The present disclosure provides a baby bottle nipple and configurations thereof that solves each of the described concerns. Other benefits and advantages will become clear from the disclosure provided herein and those advantages provided above are for illustration.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a bottle assembly is provided. The bottle assembly may include a bottle having a storage chamber and a removable cap mounted on the bottle. In addition, the assembly may include a nipple mounted on the removable cap having an opening and sealing wall. The sealing wall may form an air space preventing passage of a liquid from the storage chamber through the opening when subject to normal atmospheric conditions.

In accordance with another aspect of the present disclosure, a nipple for a baby bottle is provided. The nipple may include a wall section defining an interior chamber and a sealing wall within the interior chamber forming an air space. The air space may prevent passage of a liquid through the sealing wall when subject to normal atmospheric conditions and may permit passage of the liquid through the sealing wall when subject to an applied pressure differential.

In accordance with yet another aspect of the present disclosure, a nipple is provided. The nipple may include an opening and an interior chamber. In addition, the nipple may include a sealing wall within the interior chamber forming an air space before the opening. The air space may prevent liquid from passing through the sealing wall out of the opening under normal atmospheric conditions.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a top perspective view of an exemplary nipple secured onto a bottle through a cap in accordance with one aspect of the present disclosure;

FIG. 2 is a top perspective view of the exemplary nipple and cap in accordance with one aspect of the present disclosure;

FIG. 3 is a side view of the exemplary nipple and cap in accordance with one aspect of the present disclosure;

FIG. 4 is a top view of the exemplary nipple and cap in accordance with one aspect of the present disclosure;

FIG. 5 is a bottom view of the exemplary nipple and cap in accordance with one aspect of the present disclosure;

FIG. 6A is a cross sectional side view of the exemplary nipple and cap having a single aperture in a sealing wall in accordance with one aspect of the present disclosure; and

FIG. 6B is a cross sectional side view of the exemplary nipple and cap having multiple apertures in the sealing wall in accordance with one aspect of the present disclosure.

### DESCRIPTION OF THE DISCLOSURE

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

The present disclosure relates to a baby bottle nipple and provides multiple configurations to that system. More particularly, this disclosure describes a nipple for reducing or preventing the amount of liquid released due to accidental spillage when a baby is not feeding. In one illustrative embodiment, the nipple may include an opening and an interior chamber. A sealing wall within the interior chamber may form an air space before the opening of the nipple. The air space may prevent passage of a liquid through the sealing wall when subject to normal atmospheric conditions and may permit passage of the liquid through the opening when subject to an applied pressure differential.

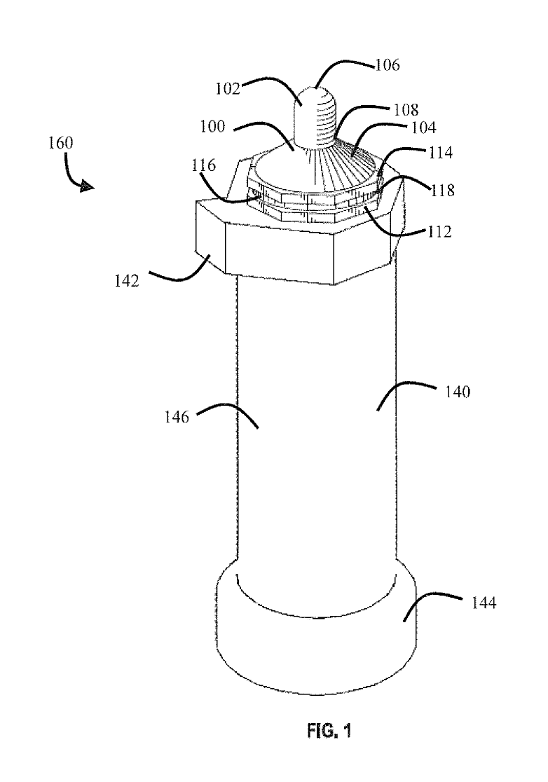

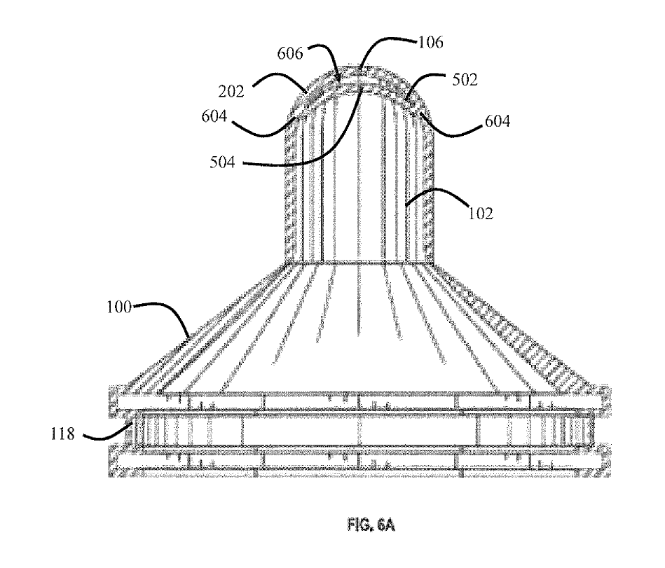

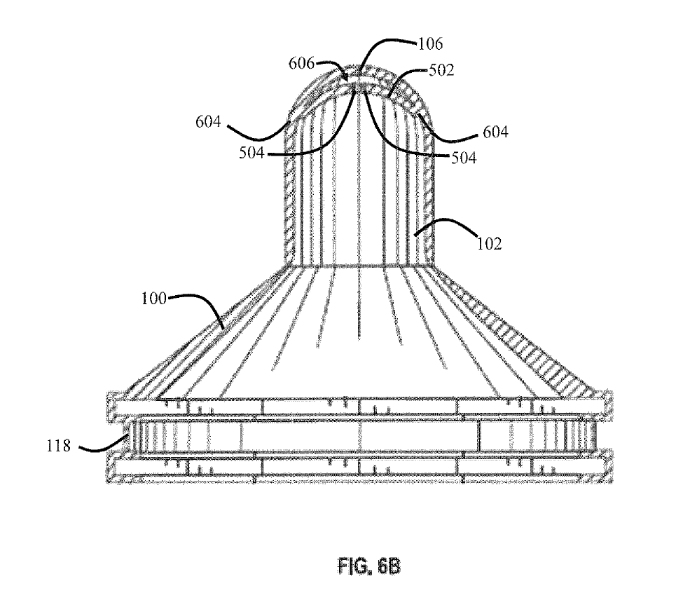

Numerous other modifications or configurations for the baby bottle nipple will become apparent from the description provided below. Advantageously, the structure of the nipple may reduce the amount of leakage when a baby is not feeding. The nipple may prevent liquid from spilling out of the top as the air space seals the sealing wall allowing only the liquid previously held in the air space to leak out. Other advantages will become apparent from the description provided below. The present disclosure will disclose an environment for the baby bottle nipple in FIG. 1, followed by different viewing angles in FIGS. 2 through 5. FIGS. 6A and 6B provide cross sectional views of different configurations for the nipple.

Turning to FIG. 1, a top perspective view of an exemplary nipple 100 secured onto a bottle 140 in accordance with one aspect of the present disclosure is provided. The nipple 100 may be part of a bottle assembly 160. The bottle assembly 160 may include a substantially cylindrical bottle 140, a ring-shaped cap 118, and an elastomeric nipple 100 extending through an opening formed in the cap 118.

The bottle 140 may come in a number of different shapes and sizes and is not limited to that shown. The bottle 140 may be cylindrical and be made of a suitable plastic. The bottle 140 may include a storage chamber 146. The storage chamber 146 may hold formula, breast milk, water, or other fluid that a baby may drink.

The bottle 140 may also include a top 142. The top 142 may have threading to connect with the cap 118, which will be described below. In one embodiment, the cap 118 may be made of an elastic material that may allow it to be popped on/off the top 142 of the bottle 140. A flange from the top 142 of the bottle 140 may be provided for attaching the cap 118. The bottle 140 may also include a bottle base 144 allowing the bottle 140 to be positioned upwards when not in use.

The cap 118 of the bottle assembly 160 may include a bottom base portion 112 and a higher base portion 114 with a divider 116 there between. The bottom base portion 112, higher base portion 114, and divider 116 may have a threaded internal surface to attach to the threaded surface of the top 142 of the bottle 140. The exterior of the bottom base portion 112 and higher base portion 114 of the cap 118 may both be shaped. For example, and as shown, the portions 112 and 114 may be formed as octagons. The shape may provide a user with the ability to tightly secure the cap 118 to the bottle 140. The edges may allow for more force to be applied. The cap 140 may have an upper portion defining a central opening through which the nipple 100 extends.

The nipple 100 of the bottle assembly 160 may include a higher conical wall section 102, a lower conical wall section 104, and an opening 106 at the top of nipple 100. The higher conical wall section 102 and the lower conical wall section 104 may meet at a neck region 108. The higher conical wall section 102 may be molded above the lower conical wall section 104. Together, the higher conical wall section 102 and the lower conical wall section 104 may form a wall section having an interior chamber. The interior chamber of the higher conical wall section 102 may include the opening 106 and sealing wall, which will be described below. The lower conical wall section 104 of the nipple 100 may fit into the higher base portion 114 of the cap 118.

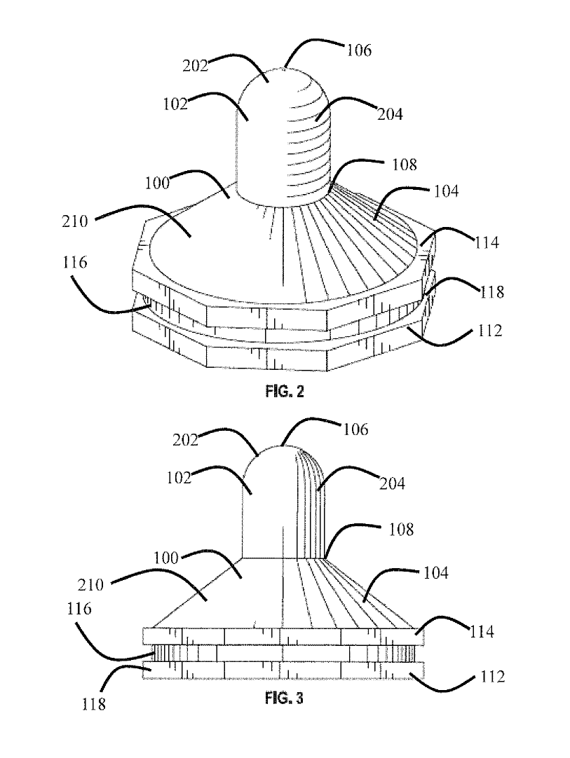

FIGS. 2 and 3 provide top perspective and side views of the exemplary nipple 100 and cap 118 in accordance with aspects aspect of the present disclosure. The cap 118, including the bottom base portion 112, divider 116 and higher base portion 114, may secure the nipple 100 into place by mounting it. The nipple 100 may be pushed through a bottom portion of the cap 118 and secured into place by the higher base portion 114. The cap 118 may be made of a suitable plastic.

The nipple 100, having the higher conical wall section 102, lower conical wall section 104, and opening 106 at the top may be made of a single piece of elastic material, or multiple pieces of material molded together. The lower conical wall section 104 includes a disk section 210 ending at the neck region 108. The disk section 210 may be secured to the higher base portion 114.

Extending from the lower conical wall section 104, at the neck region 108, may be the higher conical wall section 102. The higher conical wall section 102 may be made of a cylinder 204 and a dome 202. The cylinder 204 of the higher conical wall section 102 may extend directly upwards from the neck region 108. The dome 202, extending from the cylinder 204, may include the opening 106.

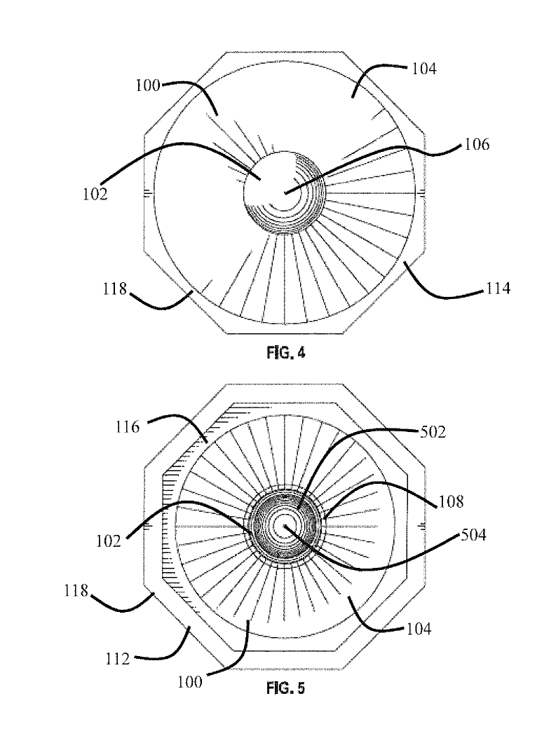

Referring to FIG. 4, a top view of the exemplary nipple 100 and cap 118 in accordance with one aspect of the present disclosure is provided. The higher conical wall section 102 having the opening 106 may extend downwards into the lower conical wall section 104. The higher conical wall section 102 may be vertical to the lower conical wall section 104.

FIG. 5 is a bottom view of the exemplary nipple 100 and cap 118 in accordance with one aspect of the present disclosure. The bottom base portion 112 of the cap 118 may be connected to the divider 116. The lower conical wall section 104 may extend from the higher base portion 114. The lower conical wall section 104 may extend into the higher conical wall section 102 at the neck region 108. The higher conical wall section 102 and the lower conical wall section 104 may form the wall section having the interior chamber.

At the neck region 108 or slightly above there, a sealing wall 502 may be provided. The sealing wall 502 may be placed in the higher conical wall section 102 above the cylinder 204 and below the dome 202. There may be an aperture 504 in the sealing wall 502. The aperture 504 may vary in size. As will be shown, an air space created between the sealing wall 502 and the dome 202 may be used to prevent further liquid from going through the bottle 140 and out of the opening 106.

FIG. 6A is a cross sectional side view of the exemplary nipple 100 and cap 118 having a single aperture 504 in the sealing wall 502 in accordance with one aspect of the present disclosure. The sealing wall 502 may be affixed to attachment areas 604 or molded therein into the higher conical wall section 102. The sealing wall 502 may be positioned slightly below the dome 202 of the higher conical wall section 102.

Through the attachment areas 604 and the sealing wall 504, an air space 606 may be created. When subjected to normal atmospheric conditions, the sealing wall 504 forming the air space 606 may prevent passage of a liquid from the storage chamber 146 of the bottle 140 through the aperture 504 and into the opening 106 at the top of the nipple 100. A small amount of liquid initially trapped within the air space 606 may leak, however, the air space 606 may be small which results in a tiny amount of lost liquid.

In an example, and when the bottle 140 is placed upside down, either accidentally or on purpose, liquid may fill the higher conical wall section 102. The air within the air space 606 however may prevent liquid from escaping through the aperture 504 in the sealing wall 504 and out of the opening 106 when a baby is not feeding. The air within the air space 606 may be placed therein after the small amount of liquid is released through the opening 106. This air may prevent leakage from the storage chamber 146. The air space 606 captures the air and typically, only the previously stored liquid in the air space 606 may leak out.

When the baby is ready to feed, an applied pressure differential may be made when the baby begins to suck the liquid from the bottle 140. The air space 606 may permit passage of the liquid from the storage chamber 146 through the opening 106 when subjected to the applied pressure differential. Liquid may be placed at the higher conical wall section 102 of the nipple 100, as the bottle 140 has been tipped in a feeding position. The sucking action causes the liquid to go through the aperture 504 in the sealing wall 502 and through the opening 106.

FIG. 6B is a cross sectional side view of the exemplary nipple 100 and cap 118 having multiple apertures 504 in the sealing wall 502 in accordance with one aspect of the present disclosure. The nipple 100 may include multiple configurations and may have two or more apertures 504 in the sealing wall 502. Similar to before, the air space 606 may be created by the sealing wall 502 with attachment areas 604 to the higher conical wall section 102 of the nipple 100. While the apertures 504 are shown evenly spaced and within the center, they may be placed on many locations on the sealing wall 502, including non-uniformly on an outer edge.

The air space 606 may prevent passage of the liquid through the sealing wall 502 within the interior chamber when subjected to normal atmospheric conditions. Thus, the sealing wall 502 may prevent liquid from the storage chamber 146 to leak out. The air space 606, on the other hand, may permit passage of the liquid through the opening 106 when subject to an applied pressure differential. Liquid may be passed through both apertures 504 in the sealing wall 502 when the pressure is applied.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A bottle assembly comprising:
a bottle having a storage chamber;
a removable cap mounted on the bottle; and
a nipple mounted on the removable cap having an opening and sealing wall, the sealing wall forming an air space preventing passage of a liquid from the storage chamber through the opening when subject to normal atmospheric conditions.

2. The bottle assembly of claim 1, wherein the air space permits passage of the liquid from the storage chamber through the opening when subject to an applied pressure differential.

3. The bottle assembly of claim 1, wherein the bottle comprises a threaded neck for mounting the removable cap.

4. The bottle assembly of claim 1, wherein the bottle comprises a flange for mounting the removable cap.

5. The bottle assembly of Claim l,wherein the nipple comprises:
a lower conical wall section; and
a higher conical wall section molded above the lower conical wall section, wherein the higher conical wall section includes the opening and sealing wall.

6. The bottle assembly of claim 5,wherein the removable cap comprises:
a bottom base portion mounted to the bottle; and
a higher base portion fitting into the lower conical wall section of the nipple.

7. The bottle assembly of claim 6, comprising a divider separating the lower base portion and higher base portion.

8. The bottle assembly of claim 5, wherein the opening and sealing wall of the nipple is at a top section of the higher conical wall section.

9. A nipple for a baby bottle, the nipple comprising:
a wall section defining an interior chamber; and
a sealing wall within the interior chamber forming an air space;
wherein the air space prevents passage of a liquid through the sealing wall when subject to normal atmospheric conditions and permits passage of the liquid through the sealing wall when subject to an applied pressure differential.

10. The nipple of claim 9, wherein the wall section defining the interior chamber comprises:
a lower conical wall section; and
a higher conical wall section molded onto the lower conical wall section, wherein the higher conical wall section includes the opening and sealing wall

11. The nipple of claim 10, wherein the higher conical wall section comprises a cylinder and dome portion.

12. The nipple of claim 10, wherein the lower conical wall section is a disk.

13. The nipple of claim 9, wherein the sealing wall is molded onto a top portion of the interior chamber.

14. The nipple of claim 9, wherein the sealing wall comprises a single aperture.

15. The nipple of claim 9, wherein the sealing wall comprises at least two apertures.

16. A nipple comprising:
an opening;
an interior chamber; and
a sealing wall within the interior chamber forming an air space before the opening, wherein the air space prevents liquid from passing through the sealing wall out of the opening under normal atmospheric conditions.

17. The nipple of claim 16, wherein the sealing wall comprises at least one aperture.

18. The nipple of claim 16, wherein the sealing wall comprises at least two apertures.

19. The nipple of claim 18, wherein the at least two apertures are placed within a center of the sealing wall.

20. The nipple of claim 16, comprising a cap securing the nipple to a bottle.
